(19) United States
(12) Patent Application Publication
(10) Pub. No.: US 2009/0140623 A1
(43) Pub. Date: Jun. 4, 2009

(54) SPARK PLUG

(76) Inventor: Hector Ugalde, Miami, FL (US)

Correspondence Address: ALBERT BORDAS, P.A., 5975 SUNSET DRIVE, SUITE 607, MIAMI, FL, 33143, US

(21) Appl. No.: 11/948,355

(22) Filed: Nov. 30, 2007

(51) Int. Cl. H01T 13/32

(52) U.S. Cl. 313/141

(57) ABSTRACT

A spark plug that comprises a terminal and a ceramic insulator. The ceramic insulator has ribs and a shaft. The ceramic insulator also has an insulator that extends from the shaft and terminates at an insulator tip. Extending from the insulator tip is a central electrode post. A ground electrode has a circular wall that extends from threads. The circular wall has a top rim. The top rim has a ridge that protrudes inwardly. The ridge terminates at an interior face.

### BACKGROUND OF THE INVENTION

1. Field of the Invention

The present invention relates to internal-combustion engine components, and more particularly, to efficient spark plugs.

2. Description of the Related Art

Spark plugs are inserted in the head of an internal-combustion engine to ignite fuel mixtures. Prior art teaches spark plugs having a housing in which there is an insulator. A longitudinal bore is present within the insulator in which a center electrode is situated. In a typical spark plug, one, two, three, or four side electrodes are fixed to the housing.

By the application of an ignition voltage, a spark forms between the center electrode and one of the side electrodes. The spark between the side electrode and the center electrode runs along a longitudinal axis of the longitudinal bore of the insulator. Between the side electrode and the center electrode, a surface gap forms, which runs over the end face of the insulator facing the combustion chamber. The center electrode is situated fitting precisely into the longitudinal bore of the insulator, or has only a slight distance from the insulator.

Because of a carbon-fouled surface of the insulator, a so-called sliding discharge, that is, a discharge between housing and insulator, is favored specifically in the starting phase, since, during the starting phase, particularly high ignition voltages are present because of a lower intake-manifold vacuum, later ignition and lower intake temperature. Such a sliding discharge may lead to problems during ignition of the air/fuel mixture in the combustion chamber and may also cause ignition misfiring.

### SUMMARY OF THE INVENTION

The instant invention remedies the above-mentioned problems that exist in the prior art spark plugs. The instant invention is a spark plug that comprises a terminal having a first end and a second end. The first end defines a distal end. A ceramic insulator has a third end and a fourth end. The third end extends from the second end. The ceramic insulator also has ribs that extend from the third end towards the fourth end but does not reach the fourth end. The ceramic insulator also has a shaft that extends from the ribs to the fourth end. The ceramic insulator also has an insulator that extends from the shaft and terminates at an insulator tip. Extending from the insulator tip is a central electrode post having a fifth end. Extending from the fifth end is a sidewall that terminates at a top wall.

This instant invention also comprises a shell that has a sixth end that extends from the fourth end. Extending from the sixth end is a nut, and extending from the nut is a body that has a face. Extending perpendicularly from the face are threads. This instant invention also comprises a ground electrode that has a circular wall that extends from the threads. The circular wall has a top rim. The top rim has a ridge that protrudes inwardly towards the center electrode post without contacting it. The ridge terminates at an interior face.

In the preferred embodiment, a first diameter of the insulator is smaller than a second diameter of the circular wall. A third diameter of the top wall is smaller than a fourth diameter of the interior face. The top wall protrudes beyond the top rim. Again, in the preferred embodiment, the ground electrode is made of platinum. In an alternate embodiment, the circular wall comprises at least one through hole.

It is therefore one of the main objects of the present invention to provide a spark plug comprising a ground electrode that has a circular wall that defines a more precise spark gap and spark.

It is another object of this invention to provide a spark plug comprising a ground electrode that has a circular wall that produces a more effective electric spark.

It is another object of this invention to provide a spark plug comprising a ground electrode that has a circular wall that reduces sliding discharge.

It is another object of this invention to provide a spark plug comprising a ground electrode that has a circular wall burns fuel mixtures that more effectively.

It is another object of this invention to provide a spark plug that does not require calibration as prior art spark plugs do.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of the preferred embodiment of the instant invention. The spark plug has been partially cross-sectioned to show the details of the ground electrode and insulator tip.

FIG. 2 represents an isometric view of a first alternate embodiment of the instant invention having horizontal oval through holes at the circular wall. The spark plug has been partially cross-sectioned to show the details of the ground electrode and insulator tip.

FIG. 3 represents an isometric view of a second alternate embodiment of the instant invention having round through holes at the circular wall. The spark plug has been partially cross-sectioned to show the details of the ground electrode and insulator tip.

FIG. 3A represents a cut view of the second alternate embodiment of the instant invention seen in FIG. 3, to show the details of the ground electrode and insulator tip.

FIG. 4 represents an isometric view of a third alternate embodiment of the instant invention having vertical oval through holes at the circular wall. The spark plug has been partially cross-sectioned to show the details of the ground electrode and insulator tip.

### DETAILED DESCRIPTION OF THE PREFERRED EMBODIMENT

Referring now to the drawings, the spark plug of the instant invention is generally referred to with numeral 10. It can be observed that the preferred embodiment basically includes terminal 20, ceramic insulator 30, shell 50, and ground electrode 80.

Instant invention 10 pierces a wall of a combustion chamber, not seen, and therefore must also seal the combustion chamber against high pressures and temperatures, without deteriorating over long periods of time and extended use.

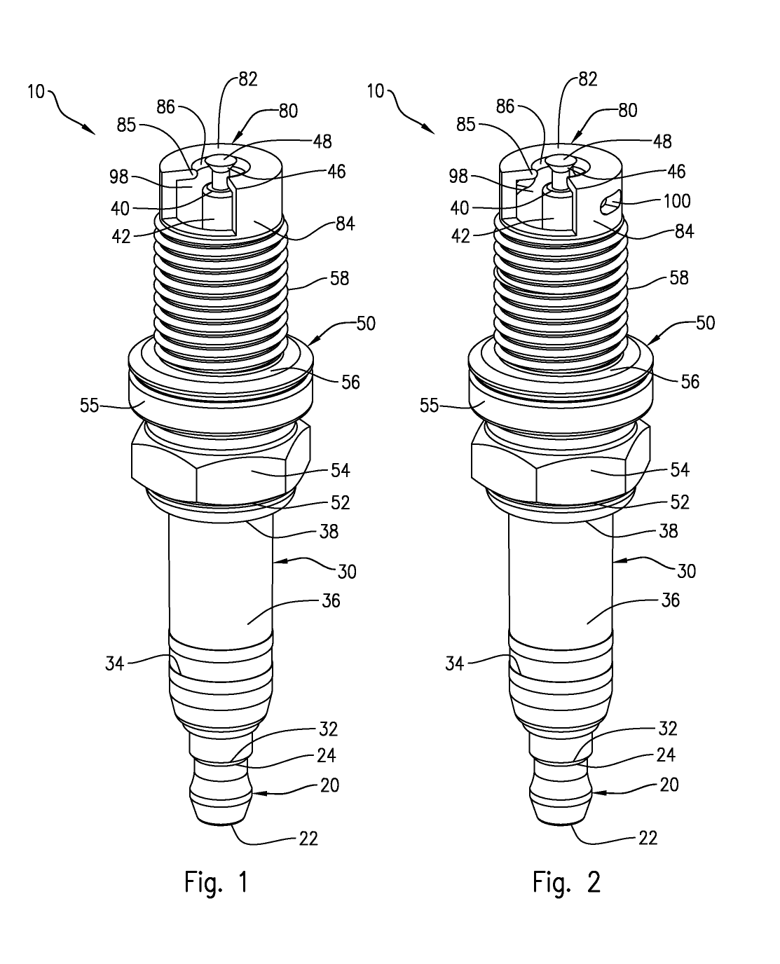

As seen in FIGS. 1, 2, 3, and 4, terminal 20 has end 22 and end 24. End 22 defines a distal end. Ceramic insulator 30 has end 32 and end 38. End 32 extends from end 24. Ceramic insulator 30 also has ribs 34 that extend from end 32 towards end 38. Ceramic insulator 30 also has shaft 36 that extends from ribs 34 to end 38. Ceramic insulator 30 also has insulator 42 that extends from shaft 36 and terminates at insulator tip 40. Extending from insulator tip 40 is central electrode post 44 having end 45. Extending from end 45 is sidewall 46 that terminates at top wall 48. Shell 50 has end 52 that extends from end 38. Extending from end 52 is nut 54. Extending from nut 54 is body 55 that has face 56. Extending perpendicularly from face 56 are threads 58.

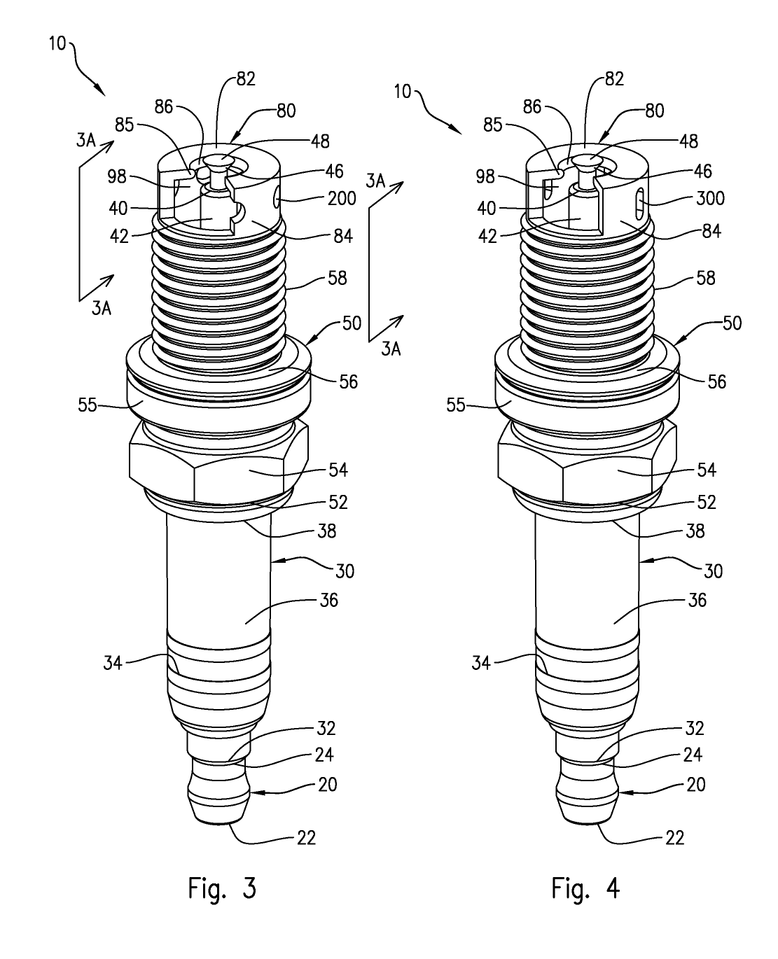

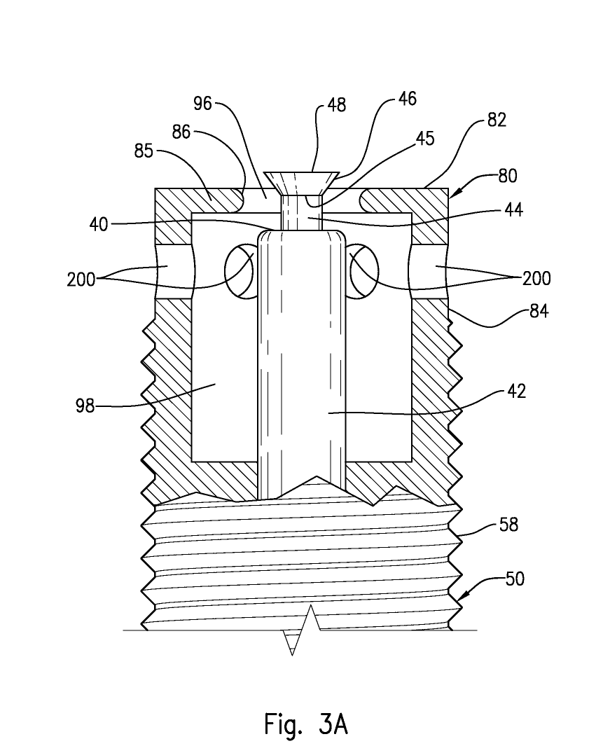

As better seen in FIGS. 3 and 3A, ground electrode 80 has a circular wall 84 that extends from threads 58. Circular wall 84 has top rim 82. Top rim 82 has ridge 85 that protrudes inwardly towards center electrode post 44 without contacting it. Ridge 85 terminates at interior face 86.

As illustrated in FIG. 3A, in the preferred embodiment, a first diameter of insulator 42 is smaller than a second diameter of circular wall 84 to define gap 98. A third diameter of top wall 48 is smaller than a fourth diameter of interior face 86 to define gap 96. It is noted that when instant invention 10 is manufactured, central electrode post 44 can be fixed to any desired height to establish a desired gap 96 measurement. Gap 96 measurement being between central electrode post 44 and/or sidewall 46 and interior face 86. Top wall 48 protrudes beyond top rim 82. Furthermore, in the preferred embodiment, ground electrode 80 is made of platinum or other material having similar characteristics. Because of the design of circular wall 84, instant invention 10 does not require calibration as prior art spark plugs do.

In alternate embodiments, circular wall 84 comprises at least one through hole, such as through holes 100 in FIG. 2, through holes 200 in FIG. 3, and through holes 300 in FIG. 4.

In general, internal combustion engines can be divided into spark-ignition engines, which require spark plugs to begin combustion, and compression-ignition engines (diesel engines), which compress the air and then inject diesel fuel into the heated compressed air mixture where it auto-ignites. Compression-ignition engines may use glow plugs to improve cold start characteristics.

In operation, instant invention 10 is connected to high voltage generated by an ignition coil or magneto. As electrons flow from the ignition coil, a voltage difference generally develops between center electrode post 44 and circular wall 84. At this moment, no current can flow because fuel and air gases in gap 96 are an insulator, but as the voltage rises further it begins to change the structure of the fuel and air gases between center electrode post 44 and circular wall 84. Once the voltage exceeds a dielectric strength of the fuel and air gases, the fuel and air gases become ionized. The ionized fuel and air gas becomes a conductor and allows electrons to flow from across gap 96 to any area of circular wall 84, and more specifically, from sidewall 46 to interior face 86. This establishes an efficient spark and prolongs the life of instant invention 10.

As the current of electrons surges across gap 96, defining a spark, it raises the temperature to approximately 60,000 K. The intense heat in gap 96 causes the ionized fuel and air gas to expand very quickly, like a small explosion. The heat and pressure force the ionized fuel and air gas to react with each other, and at the end of this event, there should be a small ball of fire in gap 96 as the ionized fuel and air gases burn on their own. The size of this fireball or kernel depends on the exact composition of the mixture between the electrodes and the level of combustion chamber turbulence at the time of the spark.

As seen in FIG. 1, instant invention 10 in the preferred embodiment is designed for compression-ignition engines such as in trucks, whereby the ionized fuel and air gases primarily burn within a narrow diameter downwardly from top wall 48.

As seen in FIG. 2, instant invention 10 in the first alternate embodiment, is designed for spark-ignition engines in automobiles, whereby the ionized fuel and air gases also burn through through holes 100. It is noted that the proximity of through holes 100 to one another and their diameter allow the ionized fuel and air gases to burn quicker and more complete than the spark plug illustrated in FIG. 1, since the fireball defined above can exit through each of the through holes 100 to allow the ionized fuel and air gases to burn quicker and more complete within a cylinder.

As seen in FIG. 3, instant invention 10 in the second alternate embodiment, is designed for spark-ignition engines in motorcycles, whereby the ionized fuel and air gases also burn through through holes 200. It is noted that the closer proximity of through holes 200 to one another and their diameter allow the ionized fuel and air gases to burn quicker and more complete than the spark plug illustrated in FIG. 2, since the fireball defined above can exit through each of the through holes 200 to allow the ionized fuel and air gases to burn quicker and more complete within a cylinder.

As seen in FIG. 4, instant invention 10 in the third alternate embodiment, is designed for spark-ignition engines in high-performance vehicles, whereby the ionized fuel and air gases also burn through through holes 300. It is noted that the closer proximity of through holes 300 to one another and their diameter allow the ionized fuel and air gases to burn quicker and more complete than the spark plug illustrated in FIG. 3, since the fireball defined above can exit through each of the through holes 300 to allow the ionized fuel and air gases to burn quicker and more complete within a cylinder.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A spark plug, comprising:
A) a terminal (20) having a first end (22) and a second end (24), said first end (22) defining a distal end;
B) a ceramic insulator (30) having a third end (32) and a fourth end (38), said third end (32) extends from said second end (24), said ceramic insulator (30) also having ribs (34) that extend from said third end (32) towards said fourth end (38) without reaching said fourth end (38), said ceramic insulator (30) also having shaft (36) that extends from said ribs (34) to said fourth end (38), said ceramic insulator (30) also having insulator (42) that extends from shaft (36) and terminates at insulator tip (40), extending from said insulator tip (40) is central electrode post (44) having fifth end (45), extending from said fifth end (45) is sidewall (46) that terminates at top wall (48);
C) a shell (50) having a sixth end (52) that extends from said fourth end (38), extending from said sixth end (52) is nut (54), extending from said nut (54) is body (55) that has face (56), extending perpendicularly from said face (56) are threads (58); and
D) a ground electrode (80) having a circular wall (84) that extends from said threads (58), said circular wall (84) having a top rim (82), said top rim (82) having a ridge (85) that protrudes inwardly towards said center electrode post (44) without contacting said center electrode post (44), said ridge (85) terminating at interior face (86).

2. The spark plug set forth in claim 1, further characterized in that a first diameter of said insulator (42) is smaller than a second diameter of said circular wall (84).

3. The spark plug set forth in claim 1, further characterized in that a third diameter of said top wall (48) is smaller than a fourth diameter of said interior face (86).

4. The spark plug set forth in claim 1, further characterized in that said top wall (48) protrudes beyond said top rim (82).

5. The spark plug set forth in claim 1, further characterized in that said circular wall (84) comprises at least one through hole.

6. The spark plug set forth in claim 1, further characterized in that said ground electrode (80) is platinum.

7. A spark plug, comprising:
A) a terminal (20) having a first end (22) and a second end (24), said first end (22) defining a distal end;
B) a ceramic insulator (30) having a third end (32) and a fourth end (38), said third end (32) extends from said second end (24), said ceramic insulator (30) also having ribs (34) that extend from said third end (32) towards said fourth end (38) without reaching said fourth end (38), said ceramic insulator (30) also having shaft (36 that extends from said ribs (34) to said fourth end (38), said ceramic insulator (30) also having insulator (42) that extends from shaft (36) and terminates at insulator tip (40), extending from said insulator tip (40) is central electrode post (44) having fifth end (45), extending from said fifth end (45) is sidewall (46) that terminates at top wall (48);
C) a shell (50) having a sixth end (52) that extends from said fourth end (38), extending from said sixth end (52) is nut (54), extending from said nut (54) is body (55) that has face (56), extending perpendicularly from said face (56) are threads (58); and
D) a ground electrode (80) having a circular wall (84) that extends from said threads (58), said circular wall (84) having a top rim (82), said top rim (82) having a ridge (85) that protrudes inwardly towards said center electrode post (44) without contacting said center electrode post (44), said ridge terminating at interior face (86), a first diameter of said insulator (42) is smaller than a second diameter of said circular wall (84).

8. The spark plug set forth in claim 7, further characterized in that a third diameter of said top wall (48) is smaller than a fourth diameter of said interior face (86).

9. The spark plug set forth in claim 8, further characterized in that said top wall (48) protrudes beyond said top rim (82).

10. The spark plug set forth in claim 9, further characterized in that said circular wall (84) comprises at least one through hole.

11. The spark plug set forth in claim 10, further characterized in that said ground electrode (80) is platinum.
